(19) United States
(12) Patent Application Publication
(10) Pub. No.: US 2018/0064131 A1
(43) Pub. Date: Mar. 8, 2018

(54) CHILLED OR FROZEN PRODUCT PREPARATION MACHINE

(71) Applicant: NESTEC S.A., Vevey (CH)

(72) Inventor: Andre Noth, Pully (CH)

(21) Appl. No.: 15/563,729

(22) PCT Filed: Apr. 4, 2016
(86) PCT No.: PCT/EP2016/057367

§ 371 Date: Oct. 2, 2017

(30) Foreign Application Priority Data
Apr. 7, 2015 (EP) 15162530.8

(51) Int. Cl. A23G 9/12; B01F 15/06; B01F 7/16; B01F 7/30; B01F 7/00

(52) U.S. Cl. CPC A23G 9/12; B01F 15/065; B01F 2015/00642; B01F 7/30; B01F 7/0095; B01F 7/1605

(57) ABSTRACT

The invention relates to a stirring mechanism (90) for a machine for preparing chilled or frozen products comprising one motor, the stirring mechanism (90) comprising an input shaft (94) rotatable by the motor and an output shaft (98) providing the output movement of the stirring mechanism (90) such that depending on the direction of rotation of the input shaft (94), the positioning of the output shaft (98) is different with respect to the input shaft (94). Further, the invention relates to a machine (100) for preparing chilled or frozen products comprising a stirring mechanism (90) as described, the stirring mechanism (90) entraining in rotation stirring means (9) to prepare the product. Even further, the invention relates to a system comprising a machine (100) as the one described and a container (10) comprising the ingredient or ingredients for preparing the product by the rotation of the stirring means (9).

### FIELD OF THE INVENTION

The present invention is directed to a machine for preparing a plurality of chilled or frozen products such as ice-cream, milkshakes, sorbets, frozen or whipped yoghurt or the like. In particular, the invention is directed to the stirring device in such a preparation machine.

### BACKGROUND OF THE INVENTION

Currently, a known solution for the fresh preparation of texturized chilled or frozen products such as ice-cream, milkshakes, sorbets, frozen yoghurt, whipped yoghurt, smoothies, cold beverages or the like is to use machines, such as blender, yoghourt maker or ice-cream maker to produce fresh products of the type previously referred to.

Solutions have been provided to allow the preparation of texturized chilled or frozen products in a reduced amount of time, departing from liquid initial ingredients at ambient temperature. An example is provided in EP 12190562.4 belonging to the same applicant, where a system allowing the preparation of fresh chilled or frozen products in a reduced time of around 5 minutes is described, this system allowing the preparation of desserts in containers that are prefilled with product and which are cooled through a thermally conductive part in these containers. The system in EP 12190562.4 comprises a device and a container; the container comprises the liquid ingredients at ambient temperature to prepare the final product. The preparation process encompasses cooling and mixing, as well as air incorporation, with the product staying in the original container. Another example is that in EP 14167344.2 where the ingredients for the preparation of the products are provided by a disposable dispensing container directly into the container where the preparation process will take place.

In any of the cases described above, for a good aeration and to ensure a fast and homogeneous heat transfer to the product from the walls of the thermally conductive parts in the container, a stirring device is of primary importance.

Known stirring devices comprise a stirrer typically provided with two rotations: a first rotation of the stirrer around its own axis, typically known as spin rotation; and a second rotation of the stirrer around the container axis, typically known as gyration. The combination of these two rotations, known as epicyclical movement, of the stirrer is able to provide good aerated desserts which are cooled in a short time.

This epicyclical movement is used in known food preparation machines, such as Hobart® or Kitchenaid®, comprising one motor that creates the two rotations of the stirrer. Besides, these machines are typically designed to maintain a certain distance between the stirrer and the inner diameter of the container: however, it would be preferable that this distance is adjusted to the type of product that is prepared in the container; typically, when preparing frozen ice-cream, for example, the product should be scrapped very close to the border of the preparation container, whereas when preparing products such as whipped yoghourt, no scrapping is needed and a certain distance should be maintained between the stirrer and the container.

Machines envisaging an adjustment on the distance of the stirrer with respect to the inner diameter of the container would either be made much more complex, heavier and more costly, requiring specific devices to allow this adjustment. The other possibility would be that these machines would allow a manual adjustment of this distance, which would not be optimum for the consumer.

The present invention comes to solve the above-described problems, as it will be further explained. The invention also aims at other objects and particularly the solution of other problems as will appear in the rest of the present description.

### OBJECT AND SUMMARY OF THE INVENTION

According to a first aspect, the invention refers to a stirring mechanism for a machine for preparing chilled or frozen products comprising one motor, the stirring mechanism comprising an input shaft rotatable by the motor and an output shaft providing the output movement of the stirring mechanism such that depending on the direction of rotation of the input shaft, the positioning of the output shaft is different with respect to the input shaft.

Preferably, the positioning of the output shaft is given by a radius value rᵢ which is the distance between the centre of the output shaft and the centre of the input shaft. The radius value rᵢ is directly related to the distance between stirring means and the inner walls in a preparation container in the machine for preparing chilled or frozen products.

Typically, the distance between the stirring means and the inner walls in the preparation container is comprised between 0 and 10 mm, more preferably between 0.5 and 10 mm.

The stirring mechanism further preferably comprises a rotating support onto which the output shaft is mounted such that when the input shaft contacts the rotating support it entrains in rotation the output shaft. Typically, the rotating support is arranged in such a way that it can rotate a certain angle in the stirring mechanism, this angle being determined by two stops.

According to the invention, the stirring mechanism can further comprise one or a plurality of transmission paths between an input shaft rotatable at a speed ωᵢₙ by the motor and an output shaft rotatable at a speed ωᵢₙ, the transmission paths providing different values of the ratio ωᵢₙ/ωₒᵤₜ and being selectable as a function of the direction of rotation of the input shaft.

According to one embodiment, the transmission paths comprise transmission gears arranged at different heights in the stirring mechanism. Preferably, the output shaft comprises one or a plurality of gear stages engaging with transmission gears as a function of the direction of rotation of the input shaft such that different ratios ωᵢₙ/ωₒᵤₜ can be provided depending on the product. Preferably, the transmission gears are arranged in the input shaft.

Preferably, according to the invention, the output shaft comprises two gear stages engaging with transmission gears depending on the direction of rotation of the input shaft, so two different ratios ωᵢₙ/ωₒᵤₜ are provided as a function of the product. According to another embodiment, the stirring mechanism of the invention is configured such that it comprises a disengagement angle α₁ where the input shaft rotates while the output shaft remains static.

Preferably, the stirring mechanism comprises first and second contacting elements collaborating with the input shaft in order to define the disengagement angle α₁.

According to a second aspect, the invention refers to a machine for preparing chilled or frozen products comprising a stirring mechanism as previously described, the stirring mechanism entraining in rotation stirring means to prepare the product.

According to a third aspect, the invention refers to a system comprising a machine as described before and a container comprising the ingredient or ingredients for preparing the product by the rotation of the stirring means.

### BRIEF DESCRIPTION OF THE DRAWINGS

Further features, advantages and objects of the present invention will become apparent for a skilled person when reading the following detailed description of embodiments of the present invention, when taken in conjunction with the figures of the enclosed drawings.

FIG. 1 shows the different main elements of a system for preparing chilled or frozen products, comprising a chilled or frozen product preparation machine according to the present invention.

FIG. 2 shows the epicyclical movement of a stirring element with a combination of two rotational speeds, in the known prior art.

FIGS. 3a-c show different views of a stirring mechanism in a chilled or frozen product preparation machine according to the present invention.

FIG. 4 shows a detailed view of the stirring mechanism modifying the radiuses in a chilled or frozen product preparation machine according to the present invention.

FIG. 5 shows the two possible radiuses provided by a stirring mechanism in a chilled or frozen product preparation machine according to the present invention.

FIG. 6 shows the configuration of the stirring mechanism rotating in the clockwise direction with a radius r₁ in a chilled or frozen product preparation machine according to the present invention.

FIG. 7 shows the configuration of the stirring mechanism rotating in the counterclockwise direction with a radius r₂ in a chilled or frozen product preparation machine according to the present invention.

### DETAILED DESCRIPTION OF EXEMPLARY EMBODIMENTS

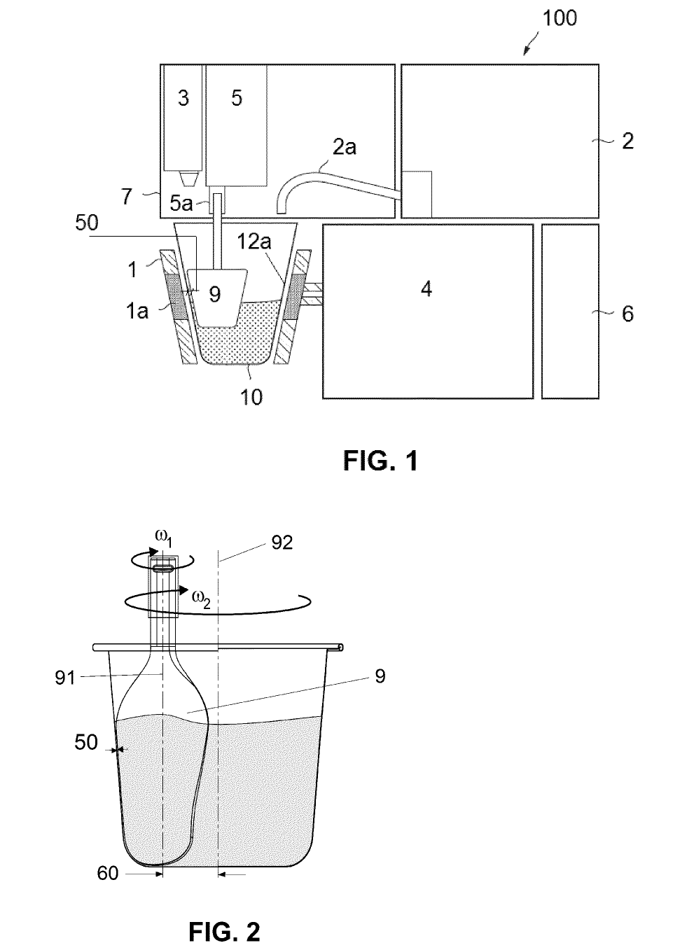

FIG. 1 relates to a preferred embodiment of a system comprising a chilled or frozen product preparation machine 100 according to the present invention and a preparation container 10. The preparation container 10 preferably comprises the ingredient or ingredients that will be processed by the preparation machine 100 in order to obtain the final chilled or frozen product targeted. Another possibility is that these ingredients have been dispensed into the preparation container 10 from a dispensing container, preferably disposable. Typically, depending on the product to be prepared in the respective container 10, its size and volume will be adapted to contain a predefined amount of ingredients necessary for preparing the specific targeted product. In what follows in the present description, both possibilities should be comprised within the scope of the present invention: the container 10 already comprising the ingredients, or a dispensing container delivering the ingredients into the container 10.

As schematically shown in FIG. 1, the preparation machine 100 preferably comprises receiving means 1 for receiving the preparation container 10 therein, preferably shaped in V-form when seen in sectional side view. According to such an embodiment, containers 10 of different sizes respectively volumes may be supported by the receiving means 1.

The preparation machine 100 further comprises a cooling unit 4 connected to a cooling element 1a that is preferably connected to or integrally formed with the receiving means 1 of the machine 100. The cooling element 1a is preferably an evaporator connected to the cooling unit 4 of the machine, preferably arranged at an inner surface of the receiving means 1. The cooling element 1a thus serves as a heat exchanger that withdraws the heat energy from the container 10 and its enclosed confectionary product. The cooling element 1a is further of a material which provides excellent heat transfer properties, such as e.g. metal. Accordingly, the heat transfer between the container 10 and the cooling element 1a is significantly enhanced.

The cooling unit 4 of the machine 100 is adapted to cool the cooling element 1a. The cooling unit 4 can comprise any refrigeration and/or circulatory heat transfer system to cool the cooling element 1a and consequently the container 10 as rapidly as possible.

The machine 100 may comprise a liquid tank 2 for holding liquid such as e.g. water and a dedicated pump. The liquid tank 2 is preferably connected to liquid dispensing means 2a for providing liquid to the container 10 when being placed within the receiving means 1 of the machine 100.

Furthermore, the machine 100 may comprise a topping tank 3 and an associated valve or pump (not shown) for providing toppings in solid or liquid form to the product prepared in the container 10. The toppings may be liquid coulis, liquid chocolat, caramel or solid products like crisps, flakes, chocolate bits. Additionally, the toppings may be liquefied by means of an additionally provided heating source such as e.g. melted chocolate.

The machine 100 further comprises a stirring device 5 adapted to connect to stirring means 9. For this reason, the stirring device 5 is preferably equipped with connection means 5a designed for selectively connecting to the stirring means 9. The stirring means 9 may either be part of the machine 100 or be provided as integral part of the container 10.

The machine 100 further comprises a control unit 6 for controlling the operations of the components of the machine. The control unit 6 may further comprise sensors and container recognition means (not shown) which are arranged to interact with identification means provided on the container 10.

The topping tank 3 and the stirring device 5 are preferably mounted on a mobile structure 7 of the machine in order to allow the insertion and removal of the container 10 into and from the container receiving means 1. The mobile structure 7 is thus adapted to be moved relatively to the rest of a housing of the machine 100 from a closed position (shown in FIG. 1) to an open position (not shown). Thereby, the movement of the mobile structure 7 with respect to the rest of the machine 100 may be rotation or translation.

The present invention specifically refers to a stirring device 5 in the preparation machine 100: in order to aerate and to ensure a fast heat transfer to the product in the container 10, stirring is a key factor and is done through an epicyclical movement of the stirring means 9, meaning that two rotations are used, as schematically represented in FIG. 2:
a first rotation ω₁ of the stirring means 9 around its own axis (stirring means axis 91), called rotation;
a second rotation ω₂ of the stirring means 9 around the container axis 92, called gyration.

As represented in FIG. 2, the stirring means 9 are arranged at a positioning distance 60 with respect to the container axis 92: therefore, the stirring mechanism 90 rotates at gyration ω₂ with respect to the container axis 92 at a positioning distance 60. Also, as shown in FIG. 2, there is a certain distance, called in what follows inner distance 50, between the stirring means 9 and the inner wall of the container 10: this means that the stirring means 9 are arranged in close vicinity of the inner freezing surface 12a of the container 10 (as represented in FIG. 1, this is the inner surface of the container 10 close to the cooling element 1a) such that a portion of the product to be prepared is stirred and scraped on the mentioned inner freezing surface 12a. That is to say, the stirring means 9 is preferably positioned at the inner freezing surface 12a of the container 10 in vicinity of the cooling element 1a when the container 10 is placed in the machine 100 (see FIG. 1). Accordingly, the product to be cooled may be scraped between the stirring means 9 and the inner cooling surface 12a which is cooled by the cooling element 1a of the machine 100 (product in the inner distance 50).

With the described configuration, the cooling of the product works efficiently. In particular, the transmission of the cold temperature from the cooled surfaces of the cooling element 1a to the liquid or semi-liquid product can be homogenized by rotating the stirring means 9. Further, any amount of product, which freezes on the cooled surfaces and in particular on the inner freezing surface 12a, can be scraped off by the stirring means 9.

However, this inner distance 50 would need to be preferably modified depending on the product prepared in the container 10. As such, certain types of products, such as frozen ice-cream, would need to be scrapped very close to the border of the container 10, whereas it is preferable not to scrap and have a bigger inner distance 50 between the stirring means 9 and the inner freezing surface 12a for other types of preparations, such as whipped yoghourt, for example.

The present invention therefore provides a machine 100 that is able to adjust or modify this inner distance 50, preferably between a lower value of zero (direct contact of the stirring means 9 and the inner freezing surface 12a), more preferably of 0.5 mm that will allow scrapping the product that freezes in the inner freezing surface 12a and a higher value preferably of around 10 mm where the product is not scrapped but the inner distance 50 allows that a better aeration and homogenization of the product is achieved. The way this is provided by the machine 100 of the invention will be explained in what follows.

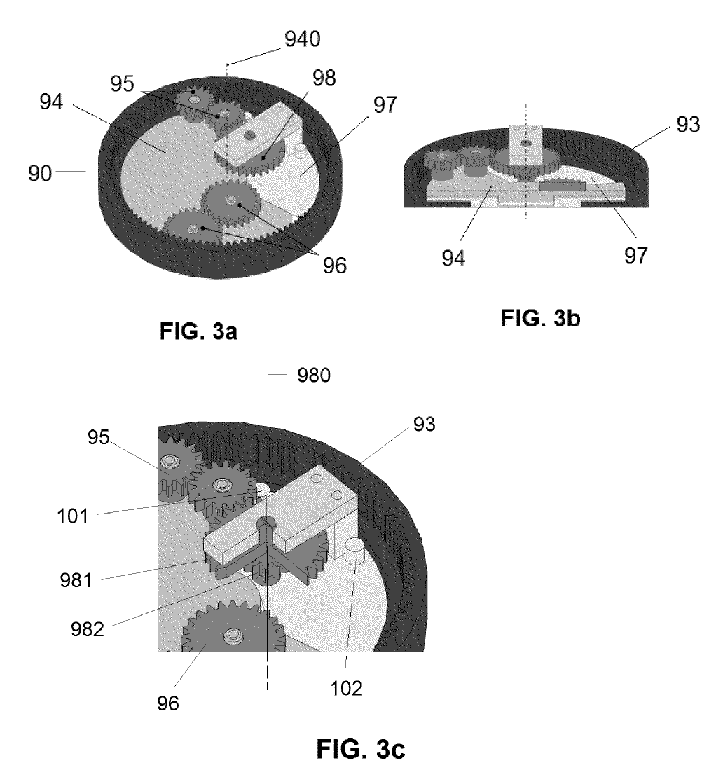

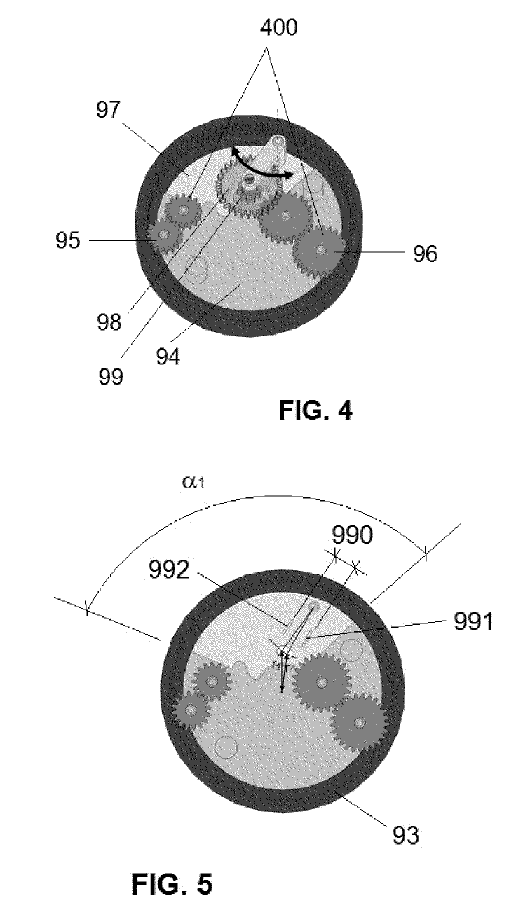

As shown in FIGS. 3a-b-c and FIG. 4, the stirring mechanism 90 of the invention preferably comprises an input shaft 94 that is actively driven in rotation by a motor around the input shaft axis 940 (should correspond to the container axis 92 as the stirring mechanism 90 is aligned with the container axis 92) and an output shaft holder 97 entrained in rotation by the input shaft 94, also rotating around the same input shaft axis 940. The stirring mechanism 90 further comprises an output shaft 98 that is mounted on a rotating support 99 that can rotate on the output shaft holder 97 a certain free angle 990 determined by two mechanical stops 991 and 992. The rotating support 99 is driven by the input shaft 94 when it enters into mechanical contact with it, independently on the direction of rotation of the input shaft 94. Therefore, when the input shaft 94 rotates, it contacts mechanically the rotating support 99 and therefore entrains in rotation the output shaft holder 97 together with the output shaft 98. As described, the rotating support 99 is preferably designed as such, to move in rotation a certain free angle 990. However, it can also be configured as a translation support in which case it will translate a certain free distance typically comprised between two stops, similar as the case previously described. This second configuration of the support 99 is more complex to execute, but leading to the same effect as the first one. Both possible configurations should therefore be comprised within the scope of the present invention.

The input shaft 94 therefore rotates at on, entrained by the motor, around the input shaft axis 940 and the output shaft 98 rotates around its output shaft axis 980 at wow, entrained in rotation by the gear arrangements 400 moved by the input shaft 94.

The stirring mechanism 90 further comprises gear arrangements 400, preferably arranged in the input shaft 94, engaging with the output shaft 98: in this way, the stirring means 9, typically arranged at the center 300 of the output shaft, are provided with a rotation ωᵢₙ around the container axis 92 (this is given by the output shaft 98 engaging with the gear arrangements 400) and a rotation ωₒᵤₜ around the stirring means axis 91 (this is given by the motor moving the input shaft 94).

When described that the input shaft 94 is actively driven in rotation by the motor around the container axis 92 several possibilities should effectively be understood and therefore comprised within the scope of the present invention: either the motor directly acts on the input shaft 94, i.e. directly drives it, or it acts on the input shaft 94 not directly, but through a transmission path such as gears or the like.

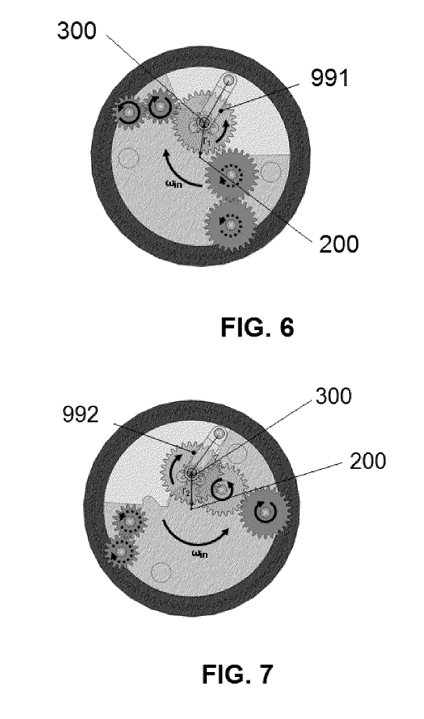

Depending on the direction of rotation of the input shaft 94, it engages the rotating support 99 on one of its sides or on the opposite side, moving it and making it contact a first stop 991 or a second stop 992. Each of these stops provides a different radius value to the stirring mechanism 90: by radius should be understood the distance between the center 300 of the output shaft and the center 200 of the input shaft (corresponding to the input shaft axis 940 and to the container axis 92). Therefore, as shown in FIG. 6, the first stop 991 is associated to a radius r₁ and the second stop 992 is associated to a radius r₂. This means that, when the input shaft 94 rotates in clockwise direction (ωᵢₙ in FIG. 6) the output shaft 98 rotates with respect to the center 200 of the input shaft (therefore, with respect to the container axis 92) according to a radius r₁ defining a certain inner distance 50 between the stirring means 9 and the inner freezing surface 12a. Looking at FIG. 5, this value of r₁ would be related to products that are not scrapped and which maintain a certain inner distance 50, such as whipped yoghourt.

Similar reasoning applies to FIG. 7, where it is shown that the second stop 992 is associated to a radius r₂. This means that, when the input shaft 94 rotates in counterclockwise direction (ωᵢₙ in FIG. 6) the output shaft 98 rotates with respect to the center 200 of the input shaft (therefore, with respect to the container axis 92) according to a radius r₂ defining a certain inner distance 50 between the stirring means 9 and the inner freezing surface 12a. Looking at FIG. 5, this value of r₂ (should be considered that r₂>r₁) would be related to products that are scrapped very close to the inner freezing surface 12a such that the inner distance 50 is very low, which would be the case for example for frozen ice-cream.

Therefore, according to the invention, the stirring mechanism 90 allows to change the distance between the two axes of rotation (the input shaft axis 940 and the output shaft axis 980) depending on the direction of rotation of the input shaft 94, clockwise or counterclockwise. Therefore, different radiuses are provided that correspond to different values of the inner distance 50, so the product can be scrapped or not in the inner freezing surface 12a, depending on the type of product being prepared. In fact, by changing the direction of rotation of the input shaft 94, the output shaft 98 takes two different locations within the output shaft holder 97, each location having a different radius with respect to the center 200 of the input shaft which corresponds to the center of the output shaft holder 97.

Additionally, as represented in FIGS. 6 and 7, the stirring mechanism 90 of the invention can also be configured in such a way that different speed ratios (ωᵢₙ/ωₒᵤₜ) are provided depending on the direction of rotation of the input shaft 94.

Preferably, as shown in FIGS. 3a-b-c, and 4-7, the stirring mechanism 90 of the invention comprises the following components:
a fixed internal gear 93 that is fixedly attached to the machine 100;
an input shaft 94 that is actively driven in rotation by a motor around the input shaft axis 940; primary transmission gear 95 and secondary transmission gear 96 are preferably arranged on the input shaft 94, each preferably comprising more than one gear and being arranged at two different heights in the input shaft 94;
an output shaft holder 97 entrained in rotation by the input shaft 94, also rotating around the same input shaft axis 940;
an output shaft 98 solitary to the output shaft holder 97 driving the stirring means 9 under rotations ω₁ and ω₂ for preparing the chilled or frozen product targeted.

Because the preparation machine 100 of the invention is used for a large variety of chilled or frozen products such as ice-cream, milkshakes, sorbets, frozen yoghurt, whipped yoghurt, smoothies, cold beverages or the like, more than one ratio (ωᵢₙ/ωₒᵤₜ) needs to be provided by the stirring mechanism 90 of the invention, as a function of the targeted product. The quotient of (ωᵢₙ/ωₒᵤₜ) defines the ratio of the epicyclical movement of the stirring mechanism 90. The stirring mechanism 90 of the invention comprises one motor (not shown in the Figures attached) and is able to provide with a simple configuration different ratios (ωᵢₙ/ωₒᵤₜ).

Preferably, the stirring mechanism 90 can provide two different ratios (ωᵢₙ/ωₒᵤₜ) as a function of the rotational direction of the input shaft 94, clockwise or counter clockwise direction. The switch between the two rotational directions and, thus, between the two ratios, is done fully automatically and only one motor is required. By providing different ratios, different stirring parameters are provided and therefore different product configurations are possible, while using only one motor, which maintains the machine with a simple configuration.

Preferably, the output shaft 98 comprises two gears, an upper output gear 981 and a lower output gear 982, as shown in FIGS. 3b and 3c. These two gears are preferably arranged at two different heights with respect to either the input shaft 94 or the output shaft holder 97; in fact they are arranged at different heights corresponding to those of the primary and secondary transmission gear 95, 96 respectively. Preferably, the primary transmission gear 95 is arranged at the same height as the upper output gear 981 so that they mechanically engage and the primary transmission gear entrains in rotation the upper output gear 981.

When the input shaft 94 is rotating in clockwise direction, the functioning of the different elements in the stirring mechanism 90 is schematically represented in FIG. 6. This can also be combined with the use of a radius r₁ associated to this clockwise rotation of the input shaft 94.

When a torque is applied on the input shaft 94 by the motor, the input shaft 94 starts rotating with a rotational speed ωᵢₙ while the output shaft holder 97 remains static, as the input shaft 94 and the output shaft holder 97 are arranged being disengaged under a certain relative angle α₁ between them, as shown in FIGS. 4, 5. Once the input shaft 94 contacts the rotating support 99 (on one of its sides) it engages and enters into mechanical contact with the output shaft holder 97, so the primary transmission gear 95 moving inside the teeth of the fixed internal gear 93 now engages the output shaft 98 and thus entrains it under a rotational speed ωₒᵤₜ. Specifically, the primary transmission gear 95 engages the upper output gear 981.

Using an even number of gears (two, in the preferred embodiments shown) in the primary transmission gear 95 has the consequence that the upper output gear 981 rotates in the opposite direction compared to the input shaft 94.

When the input shaft 94 is rotating in counter clockwise direction, the functioning of the different elements in the stirring mechanism 90 is schematically represented in FIG. 7. This can also be combined with the use of a radius r₂ associated to this counterclockwise rotation of the input shaft 94.

When a torque is applied on the input shaft 94 by the motor, the input shaft 94 starts rotating with a rotational speed ωᵢₙ while the output shaft holder 97 remains static, as the input shaft 94 and the output shaft holder 97 are arranged being disengaged under a certain relative angle α₁ between them, as shown in FIGS. 4-5. Once the input shaft 94 contacts the rotating support 99 it engages and enters into mechanical contact with the output shaft holder 97, so the secondary transmission gear 96 moving inside the teeth of the fixed internal gear 93 now engages the output shaft 98 and thus entrains it under a rotational speed ωₒᵤₜ. Specifically, the secondary transmission gear 96 engages the lower output gear 982.

Using an even number of gears (two, in the preferred embodiments shown) in the secondary transmission gear 96 has the consequence that the lower output gear 982 rotates in the opposite direction compared to the input shaft 94.

According to what has been described for the present invention, the stirring means 9 rotate around the container axis 92 under a rotational speed ωᵢₙ (gyration) provided by the motor to the input shaft 94. Furthermore, the stirring means 9 also rotate (spin) around its axis (stirring means axis 91) under a rotational speed ωₒᵤₜ.

According to the invention, a stirring mechanism 90 is provided comprising a plurality of transmission paths, these transmission paths being selected as a function of the direction of rotation of the input shaft 94. By transmission path, according to the present invention, it should be understood the transmission or movement path followed by the gears that are engaged or meshed which starts or departs from the input shaft 94 and ends at the output shaft 98, i.e. from ωᵢₙ provided by the motor to ωₒᵤₜ provided in the output shaft 98. According to the invention, diverse transmission paths are provided which give a certain ratio (ωₒᵤₜ/ωᵢₙ) that is chosen as a function of the chilled or frozen product prepared by the machine of the invention, this ratio (ωₒᵤₜ/ωᵢₙ) being further determined by the direction of rotation of the input shaft 94.

According to a preferred embodiment of the invention, different transmission paths can be selected as different transmission gears are arranged at different heights in the input shaft 94, further ratio selections being possible also depending on the direction of rotation of the input shaft 94.

The Figures attached and the references used indicate straight gears; however, any other kind of gears can be used and will also fall within the scope of the present invention, such as helical, double helical, spiral, hypoid, conical, or the like.

As explained previously, the main advantages of the stirring mechanism of the invention are to be able to provide different radiuses, corresponding to different scrapping of the product in the container, by means of using a simple mechanism and still using only one motor.

Although the present invention has been described with reference to preferred embodiments thereof, many modifications and alternations may be made by a person having ordinary skill in the art without departing from the scope of this invention which is defined by the appended claims.

### REFERENCES

100 Machine
1 Container receiving means
4 Cooling unit
1a Cooling element
12a Inner freezing surface
2 Liquid tank
2a Dispensing means
3 Topping tank
5 Stirring device
90 Stirring mechanism
5a Connection means
6 Control unit
7 Mobile structure
9 Stirring means
ω₁ Rotation of stirring means around own axis
ω₂ Rotation of stirring means around container axis
91 Stirring means axis
92 Container axis
93 Fixed internal gear
94 Input shaft
   940 Input shaft axis
   200 Center input shaft
400 Gear arrangements
95 Primary transmission gear
96 Secondary transmission gear
97 Output shaft holder
98 Output shaft
   980 Output shaft axis
   300 Center output shaft
981 Upper output gear
982 Lower output gear
99 Rotating support
   991 First stop
   992 Second stop
   990 Free angle between stops
α₁ Disengaging angle between output shaft holder and input shaft
ωᵢₙ Rotation of input shaft
ωₒᵤₜ Rotation of output shaft
10 Preparation container

1. Stirring mechanism for a machine for preparing chilled or frozen products comprising one motor, the stirring mechanism comprising an input shaft rotatable by the motor and an output shaft providing the output movement of the stirring mechanism such that depending on the direction of rotation of the input shaft, the positioning of the output shaft is different with respect to the input shaft.

2. Stirring mechanism according to claim 1 wherein the positioning of the output shaft is given by a radius value which is the distance between the centre center of the output shaft and the centre center of the input shaft.

3. Stirring mechanism according to claim 2 wherein the radius value is directly related to the distance between a stirring means member and the inner walls in a preparation container in the machine for preparing chilled or frozen products.

4. Stirring mechanism according to claim 3 wherein the distance between the stirring means member and the inner walls in the preparation container is comprised between 0 and 10 mm.

5. Stirring mechanism according to claim 1 comprising a rotating support onto which the output shaft is mounted such that when the input shaft contacts the rotating support it entrains in rotation the output shaft.

6. Stirring mechanism according to claim 5 wherein the rotating support is arranged in such a way that it can rotate a certain angle in the stirring mechanism, this angle being determined by two stops.

7. Stirring mechanism according to claim 1 comprising one or a plurality of transmission paths between an input shaft rotatable at a speed (ωᵢₙ) by the motor and an output shaft rotatable at a speed (ωᵢₙ), the transmission paths providing different values of the ratio (ωᵢₙ/ωₒᵤₜ) and being selectable as a function of the direction of rotation of the input shaft.

8. Stirring mechanism according to claim 7, wherein the transmission paths comprise transmission gears arranged at different heights in the stirring mechanism.

9. Stirring mechanism according to claim 7, wherein the output shaft comprises one or a plurality of gear stages engaging with transmission gears as a function of the direction of rotation of the input shaft such that different ratios (ωᵢₙ/ωₒᵤₜ) can be provided depending on the product.

10. Stirring mechanism according to claim 9, wherein the transmission gears are arranged in the input shaft.

11. Stirring mechanism according to claim 9, wherein the output shaft comprises two gear stages engaging with transmission gears depending on the direction of rotation of the input shaft, so two different ratios (ωᵢₙ/ωₒᵤₜ) are provided as a function of the product.

12. Stirring mechanism according to claim 1, configured such that it comprises a disengagement angle where the input shaft rotates while the output shaft remains static.

13. Stirring mechanism according to claim 1, comprising first and second contacting elements collaborating with the input shaft in order to define the disengagement angle.

14. Machine for preparing chilled or frozen products comprising a stirring mechanism and one motor, the stirring mechanism comprising an input shaft rotatable by the motor and an output shaft providing the output movement of the stirring mechanism such that depending on the direction of rotation of the input shaft, the positioning of the output shaft is different with respect to the input shaft, the stirring mechanism entraining in rotation stirring member to prepare the product.

15. System comprising a machine according to claim 14 and a container comprising the ingredient or ingredients for preparing the product by the rotation of the stirring member.
